(19) United States
(12) Patent Application Publication
(10) Pub. No.: US 2017/0186030 A1
(43) Pub. Date: Jun. 29, 2017

(54) ADVERTISEMENT CLICK-THROUGH RATE CORRECTION METHOD AND ADVERTISEMENT PUSH SERVER

(71) Applicant: TENCENT TECHNOLOGY (SHENZHEN) COMPANY LIMITED, Shenzhen (CN)

(72) Inventors: Lei JIANG, Shenzhen (CN); Yong LI, Shenzhen (CN); Lei XIAO, Shenzhen (CN); Dapeng LIU, Shenzhen (CN)

(21) Appl. No.: 15/455,356

(22) Filed: Mar. 10, 2017

Related U.S. Application Data
(63) Continuation of application No. PCT/CN2016/079188, filed on Apr. 13, 2016.

(30) Foreign Application Priority Data
Apr. 21, 2015 (CN) 201510191670.0

(51) Int. Cl. G06Q 30/02; G06F 17/30; G06F 17/18; G06N 5/04

(52) U.S. Cl. CPC G06Q 30/0244; G06N 5/04; G06F 17/30424; G06F 17/18

(57) ABSTRACT

The present disclosure pertains to the field of computer technologies, and discloses an advertisement click-through rate correction method and an advertisement push server. The method includes: predicting click-through rates of training samples by using a logistic regression model, to obtain predicted values associated with the click-through rates of the training samples; querying observation values of the training samples according to stored log data; and calculating correction values of the predicted values of the training samples according to the observation values of the training samples, so that in two neighboring predicted values, a correction value of the former predicted value is less than or equal to a correction value of the latter predicted value.)

### CROSS-REFERENCES TO RELATED APPLICATION

This application is a continuation application of PCT Patent Application. No. PCT/CN2016/079188, filed on Apr. 13, 2016, which claims priority to Chinese Patent Application No. 201510191670.0, filed with the Chinese Patent Office on Apr. 21, 2015 and entitled “ADVERTISEMENT CLICK-THROUGH RATE CORRECTION METHOD AND APPARATUS”, the entire contents of both of which are incorporated herein by reference.

### FIELD OF THE TECHNOLOGY

Embodiments of the present invention related to the field of computer technologies and in particular, to an advertisement click-through rate correction method and an advertisement push server.

### BACKGROUND OF THE DISCLOSURE

When pushing an advertisement, an advertiser generally requires the pushed advertisement to have a relatively high click-through rate (CTR), to ensure effective promotion of the advertisement.

An advertisement push system generally makes a click-through rate prediction based on previous user behavior as training data. However, when predicting CTRP click-through rate, due to a huge amount of training data. (which is generally thousands of orders of magnitude), non-proportional sampling is performed on positive samples and negative samples in training samples, causing a difference between a predicted CTR and an actual) CTR.

The disclosed method and system are directed to solve one or more problems set forth above and other problems.

### SUMMARY

To resolve a problem in a related technology that when a CTRP unit predicts a click-through rate, there is a difference between a predicted CTR and an actual CTR because non-proportional sampling performed on positive samples and negative samples in training samples due to a huge amount of training data, embodiments of the present invention provide an advertisement click-through rate correction method and an advertisement push server. The technical solutions are as follows:

According to a first aspect, an advertise click-through rate correction method is provided, including: predicting, by an advertisement push server, click-through rates of training samples by using a logistic regression model, to obtain predicted values associated with the click-through rates of the training samples; querying, by the advertisement push server, observation values of the training samples according to stored log data, the observation value being used for indicating, in a training sample, whether a user clicks on an advertisement in the mining sample; and calculating, by the advertisement push, server, correction values of the predicted values of the training samples according to the observation values of the training samples, so that in two neighboring predicted values including a former predicted value and a latter predicted value, a first correction value of the former predicted value is less than or equal to a second correction value of the latter predicted value, the correction value being used for replacing a corresponding predicted value when an advertisement is recommended to the user, the order of magnitude of the correction value being the same as the order of magnitude of an actual click-through rate, and in the two neighboring predicted values, the former predicted value being less than or equal to the latter predicted value.

According to a second aspect, an advertisement push server is provided, including: one or more processors; and a memory, where the memory stores one or more programs, the one or more programs are configured to be executed by the one or more processors, and the one or more programs include instructions for performing the following operations: predicting click-through rates of training samples by using a logistic regression model, to obtain predicted values of the click-through rates of the training samples; querying observation values of the training samples according to stored log data, the observation value being used for indicating, in a training sample, whether a user clicks on an advertisement in the training sample; and calculating correction values of the predicted values of the training samples according to the observation values of the training samples, so that in two neighboring predicted values, a correction value of the former predicted value is less than or equal to a correction value of the latter predicted value, the correction value being used for replacing a predicted value corresponding to the correction value when an advertisement is recommended to the user, the order of magnitude of the correction value being the same as the order of magnitude of an actual click-through rate, and in the two neighboring predicted values, the former predicted value being less than or equal to the latter predicted value,

According to a third aspect, a non-transitory computer-readable storage medium is provided, including computer-executable program for, when being executed by a processor, performing an advertisement click-through rate correction method. The method may include predicting click-through rates of training samples by using a logistic regression model, to obtain sorted predicted values associated with the click-through rates of the training samples. In two neighboring predicted values including a former predicted value and a latter predicted value, the former predicted value is no greater than the latter predicted value. The method may further include: querying observation values of the training samples according to stored log data, the observation value indicating, in a training sample, whether a user clicks on an advertisement in the training sample: and calculating correction values of the predicted values of the training samples according to the observation values of the training samples, so that in the two neighboring predicted values, a first correction value of the former predicted value is less than or equal to a second correction value of the latter predicted value, the correction value being used for replacing a corresponding predicted value of the training sample, when the advertisement corresponding to the training sample is recommended to the user.

By implementing the technical solutions provided in the embodiments of the present invention, predicted click through rates corresponding to training samples are corrected, to obtain correction values of predicted values. The order of magnitude of a correction value is the same as the order of magnitude of an actual click-through rate, that is, the correction value is closer to a click-through rate of a user. Therefore, when an advertisement is pushed to the user by replacing a predicted value with a correction value, a probability of the advertisement pushed to the user being clicked on can be greatly increased. Therefore, the present disclosure solves the problem in a related technology that when a CTRP unit predicts a click-through rate, there is a difference between a predicted CTR and an actual CTR because non-proportional sampling is performed on positive samples and negative samples in training samples due to a huge amount of training data; and achieves effects of reducing a difference between a predicted click-through rate and an actual click-through rate and improving a hit ratio of an advertisement pushed to a user.

### BRIEF DESCRIPTION OF THE DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and a person of ordinary skill in the art may still derive other accompanying drawings from these accompanying drawings without creative efforts.

FIG. 1 is a schematic structural diagram of an advertisement push server according to some embodiments of the present invention;

FIG. 2 is a method flowchart of an advertisement click-through rate correction method according to an embodiment of the present invention;

FIG. 3A is a method flowchart of an advertisement click-through rate correction method according to another embodiment of the present invention;

FIG. 3B is a schematic diagram of obtaining a correction value according to an embodiment of the present invention;

FIG. 4A is a method flowchart of an advertisement click-through rate correction method according to still another embodiment: of the present invention;

FIG. 4B is a schematic diagram of obtaining a correction value according to another embodiment of the present invention;

FIG. 5 is a structural block diagram of an advertisement click-through rate correction apparatus according to an embodiment of the present invention;

FIG. 6 is a structural block diagram of an advertisement click-through rate correction apparatus according to another embodiment of the present invention; and

FIG. 7 is a schematic structural diagram of an advertisement push server according to an embodiment of the present invention.

### DESCRIPTION OF EMBODIMENTS

To make objectives, technical solutions, and advantages of the present disclosure clearer, the following further describes embodiments of the present invention in detail with reference to die accompanying drawings.

When pushing an advertisement, an advertisement push system may push the advertisement to a user according to collected user data, log data, and advertisement data. When the advertisement push system pushes an advertisement to a user, for pushing an advertisement on which the user most possibly clicks, a retrieve unit in the advertisement push system may screen out a particular quantity (generally several thousands to tens of thousands) of advertisements according to basic information in user data of the user and orientation information in advertisement data. Further, a preliminary selection unit in the advertisement push system may preliminary select from the screened-out advertisements (usually less than several hundreds of the advertisements are selected) according, to click-through rates of the advertisements, a user interest behavior feature, and correlations between the user and advertisements. Subsequently, the preliminarily selected advertisements are subject to refined selection in a click-through rate prediction (CTRP) unit by using an established segment popularity model and an established logistic regression model, that is, click-through rates of the advertisements are predicted, and the advertisements are sorted according to the predicted click-through rates. A preset number of advertisements that have relatively high click-through rates are screened out. Further, a desired advertisement is extracted in an optimization unit by using an optimization criterion. The advertisement push system may push the extracted desired advertisement to the user. According to the foregoing screening by the advertisement push system, the advertisement pushed to the user has a relatively high possibility of being clicked on by the user.

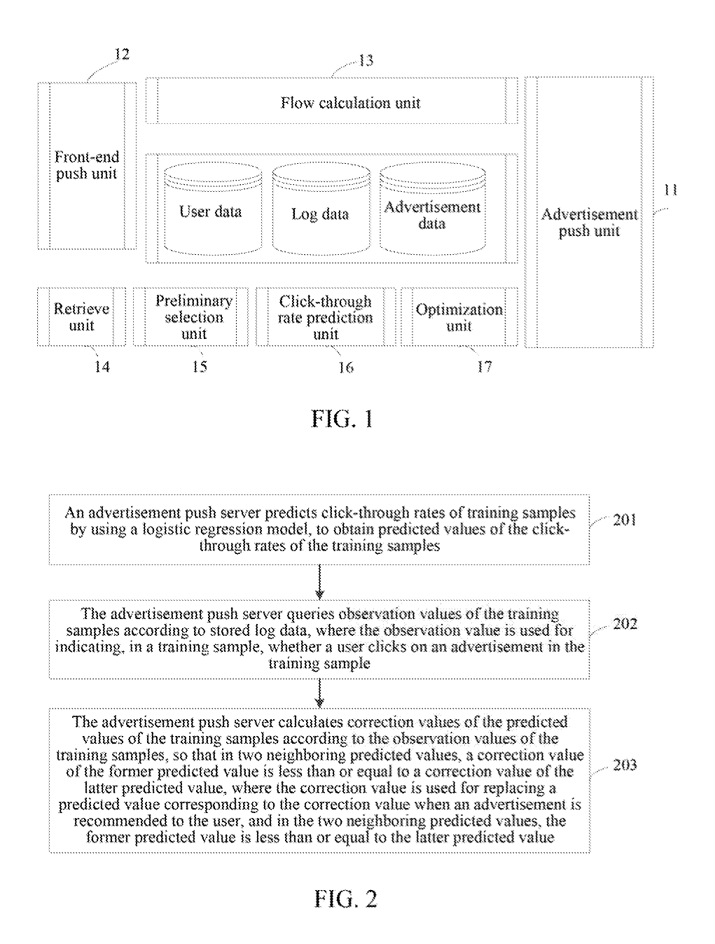

Referring to FIG. 1, FIG. 1 is a schematic structural diagram of an advertisement push server according to some embodiments of the present invention. The advertisement push server includes: an advertisement push unit 11, a front-end push unit 12, a flow calculation unit 13, a retrieve unit 14, a preliminary selection unit 15, a click-through rate prediction unit 16, and an optimization unit 17. The advertisement push server obtains and stores user data, log data, and advertisement data.

(1) The advertisement push unit 11 is configured to: receive to-be-pushed advertisements provided by advertisers, receive related data of the advertisements, (such as an advertisement targeting information, and an advertisement attribute information) and store advertisement data of each advertisement. The advertisement targeting herein is used for indicating a group of target people of an advertisement. The advertisement attribute herein is used for indicating an attribute of the group of people to which the advertisement is pushed. For example, the advertisement targeting group may be middle-aged people, fitness enthusiasts, male, female, and research personnel. The advertisement attribute may be a type of an advertisement (for example, job recruitment, item selling, event and promotion), an advertisement position, a display form of an advertisement, and the like.

(2) The front-end push unit 12 is configured to; push an advertisement to a user. When receiving an advertisement push request of a user, the front-end push unit 12 obtains user data of the user, and sends the user data of the user to the retrieve unit 14. For example, after receiving the advertisement push request of the user, the front-end push unit 12 pushes an advertisement to the user. For example, when a request indicating that the user wants to obtain an advertisement is received, or a trigger signal generated when the user clicks on a webpage link related to an advertisement is received, it may be considered that the advertisement push request of the user is received.

(3) The flow calculation unit 13 is configured to: extract information of the advertisement pushed by the advertisement push unit 11, extract the user data of the user obtained by the front-end push unit 12, or perform other necessary calculations.

(4) The retrieve unit 14 provides an advertisement retrieve function. There are hundreds of thousands of to millions of advertisements online each day. When a request of a user reaches an advertisement push system, the retrieve unit 14 performs inverse sorting according to the advertisement targeting information, and indexes advertisements according to basic information of the user. In this case, a quantity of hit advertisements that are recalled is greatly reduced. The quantity is several thousand to over ten thousand. The advertisements are processed by the preliminary selection unit 15.

(5) The preliminary selection unit 15 (for example, a scoring unit) provides an advertisement preliminary selection function. The quantity of the advertisements recalled by the preliminary selection unit 15 is over ten thousand. An advertisement system cannot predict click-through rates for over ten thousand of advertisements within milliseconds. The preliminary selection unit 15 preliminarily selects advertisements according to CTRs, effective cost per mile (WPM), user interest behavior features, and correlations between the user and the advertisements. In this case, the quantity of preliminarily selected advertisements is within several hundred, and further processing is performed by the click-through rate prediction unit 16.

(6) The click-through rate prediction unit 16 (that is, the CTRP unit) provides an advertisement CTR prediction function. CTRs of the advertisements preliminarily selected by the preliminary selection unit 15 are predicted by the click-through rate prediction unit 16. Models used in CTR prediction may include: a segment popularity model, that is, users are classified into groups according to basic user attributes such as age and gender, and statistics collection is performed on, top click-through rates in the groups; a logistic regression model, that is, a logistic regression model is established according to a user attribute, an advertisement basic attribute, an advertisement position attribute, and a crossing attribute of a user; an advertisement position, and an advertisement; and a decision tree model, that is, a tree models is established also according to the user attribute, the advertisement basic attribute, the advertisement position attribute, and the crossing attribute of the user, the advertisement position, and the advertisement. The logistic regression model is used to predict click-through rates of preliminarily selected advertisements, to obtain predicted values of the advertisements.

(7) The optimization unit 17 (for example, a re-ranking unit) provides an income optimization function. The optimization unit 17 mainly performs system optimization objective conversion on a prediction result of the click-through rate prediction unit 16. Current charging modes include cost per click (CPC), cost per action (CPA), and cost per thousand impressions (CPM). The optimization unit 17 maximizes the income by using eCPM=CTR*CPC. Moreover, freshness control also needs to be performed.

(8) The user data refers to related information of a user requesting an advertisement push, for example, gender age, and hobby.

(9) The log data refers to information generated after a user browses an advertisement. For example, the log data may include a user identifier used for uniquely identifying a user, an advertisement identifier used for uniquely identifying an advertisement, a predicted value, predicted by the click-through rate prediction unit 16, that the user (the user indicated by the user identifier) clicks on the advertisement (the advertisement indicated by the advertisement identifier), and a click-through parameter used for indicating whether the user actually clicks on the advertisement.

(10) The advertisement data refers to related information of the advertisement, for example, information such as audience, a type of the advertisement, and an advertisement position.

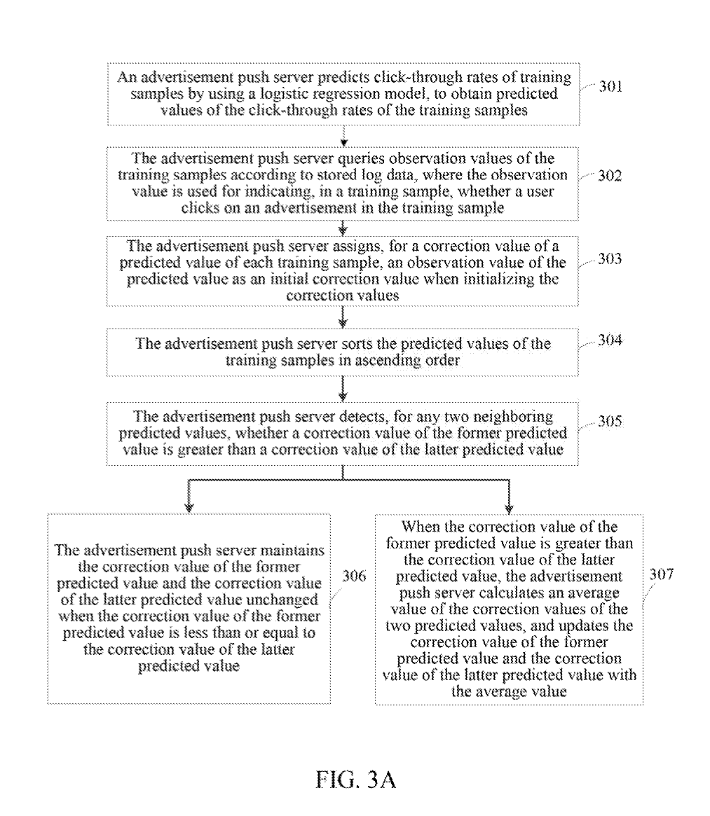

Referring to FIG. 2, FIG. 2 is a method flowchart: of an advertisement click-through rate correction method according to an embodiment of the present invention. An example in which the advertisement click-through rate correction method is applied to the advertisement push server shown FIG. 1 is mainly used for description. The advertisement click-through rate correction method may include the following.

Step 201: An advertisement push server predicts click-through rates of training, samples by using a logistic regression model, to obtain predicted values associated with the click-through rates of the training, samples.

The predicted value is a value obtained by predicting a click-through rate of a training sample by a click-through rate prediction unit in the advertisement push server.

Generally, one training sample includes one user and one pushed advertisement. Correspondingly, a predicted value of a training sample is a value obtained by predicting a click-through probability that a user in the training sample clicks on an advertisement in the training sample.

The logistic regression model is a model in the advertisement push server, and can be implemented by a person of ordinary skill in the art. Details are not described herein.

Step 202: The advertisement push server queries observation values of the, training samples according to stored log data, where the observation value is used for indicating, in a training sample, whether a user clicks on an advertisement in the training sample.

The log data usually includes a user identifier, an advertisement identifier (also referred to as an order), a predicted value, and a click-through parameter. The click-through parameter herein is used for indicating whether a user having the user identifier clicks on an advertisement having the advertisement identifier.

An observation value of a training sample is generally used for indicating whether the user in the training sample has clicked on the advertisement in the training sample. That is, the observation value of the training sample is used for indicating a click-through behavior that as been actually performed by the user on the training sample, or is used for indicating that the training sample has not been actually clicked on.

Step 203: The advertisement push server calculates correction values of the predicted values of the training samples according to the observation values of the training samples, so that in two neighboring predicted values, a correction value of the former predicted value is less than or equal to a correction value of the latter predicted value, where the correction value is used for replacing a corresponding predicted value when an advertisement is recommended to the user (e.g., the training example corresponding to the advertisement is identified, the correction value corresponding to the predicted value of the training sample is obtained), and in the two neighboring predicted values, the former predicted value is less than or equal to the latter predicted value.

The order of magnitude of the correction value is the same as the order of magnitude of an actual click-through rate. The actual click-through rate refers to a probability that the user actually clicks. Generally, an actual click-through rate ranges from 0 to I, and a calculated correction value also ranges from 0 to 1.

It may be known according to the foregoing correction manner that a small predicted value corresponds to a small correction value, and a large predicted value corresponds to a large correction value. Therefore, as can be known, an ascending direction of the correction values is the same as an ascending direction of the predicted values, and moreover, the order of magnitude of the correction value is the same as the order of magnitude of the actual click-through rate. Therefore, the correction value can better reflect an actual click-through need of the user.

In conclusion, according to the advertisement click-through rate correction method provided in this embodiment of the present invention, predicted click-through rates corresponding to training samples are corrected, to obtain correction values of predicted values. The order of magnitude of a correction value is closer to the order of magnitude of a click-through rate of a user, and an ascending direction of the correction values is the same as an ascending direction of the predicted values. Therefore, when an advertisement is pushed to the user by replacing a predicted value with a correction value, a probability of the advertisement pushed to the user being, clicked on can be greatly increased. Therefore, the advertisement click-through rate correction method solves a problem in a related technology that when a CTRP unit predicts a click-through rate, there is a difference between a predicted CTR and an actual CTR because non-proportional sampling is performed on positive samples and negative samples in training samples due to a huge amount of training data; and achieves effects of reducing a difference between a predicted click-through rate and an actual click-through rate and improving a hit ratio of an advertisement pushed to a user.

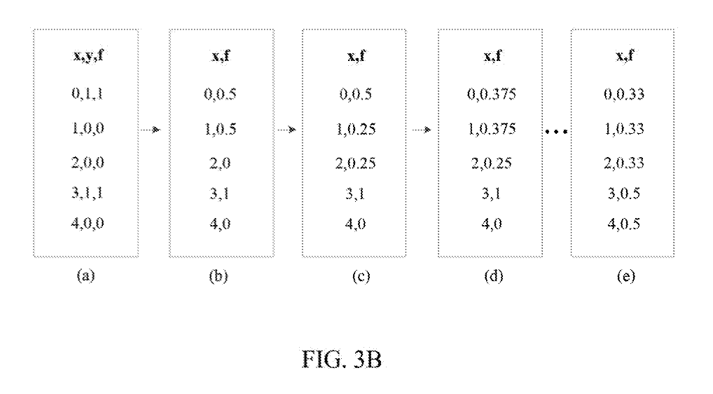

Referring to FIG. 3A, FIG. 3A is a method flowchart of an advertisement click-through rate Correction Method according to another embodiment of the present invention. An example in which the advertisement click-through rate correction method is applied to the advertisement push server shown FIG. 1 is mainly used for description. The advertisement click-through rate correction method may include the following.

Step 301: An advertisement push server predicts click-through rates of training samples by using a logistic regression model, to obtain predicted values of the click-through rates of the training samples.

The predicted value is a value obtained by predicting a click-through rate of a training sample by a click-through rate prediction unit in the advertisement push server.

Generally, one training sample includes one user and one pushed advertisement. Correspondingly, a predicted value of a training sample is a value obtained by predicting a click-through probability that a user in the training sample clicks on an advertisement in the training sample.

The logistic regression model herein may quantize related data of a user and related data of an advertisement, and outputs, according to a weight of each category of data and quantized data, a predicted value of a click-through rate of the advertisement pushed to the user. Because the logistic regression model is a common model used for predicting a click-through rate of a training sample in an advertisement push field, details are not described herein.

Step 302: The advertisement push server queries observation values of the training samples according to stored log data, where the observation value is used for indicating, in a training sample, whether a user clicks on an advertisement in the training sample.

The log data usually includes a user identifier, an advertisement identifier (also referred to as an order), a predicted value, and a click-through parameter. The click-through parameter is used for indicating whether a user having the user identifier clicks on an advertisement having the advertisement identifier.

When the user requests for an advertisement push service, the advertisement push server recommends an advertisement to the user according to historical data of the user and information about the advertisement, that is, the advertisement is exposed on a client, and the user may click on the advertisement. Correspondingly, use behaviors of the user may form a piece of log data. The piece of log data includes an identifier of the user, an identifier of the exposed advertisement, a predicted value predicted by the advertisement push server for the advertisement when the advertisement push server pushes the advertisement to the user, and a click-through parameter indicating whether the user clicks on the advertisement.

Optionally, when the user clicks on the advertisement, the click-through parameter in the log data is either 1 or 0. If the user does not click on the advertisement, the click-through parameter in the log data is the other number in 1 and 0.

In the following embodiments, an example in which the click-through parameter is used for indicating that the user clicks on the advertisement when the click-through parameter is 1 and the click-through parameter is used for indicating that the user does not click on the advertisement when the click-through parameter is 0 is used for description.

The observation value refers to an actual operation performed by the user on the advertisement, for example, the user clicks or does not click the advertisement. Therefore, the observation value is obtained according to the click-through parameter in the log data, that is, when the click-through parameter is 1, the observation value is 1, and when the click-through parameter is 0, the observation value is 0.

Step 303: The advertisement push server assigns, for a correct on value of a predicted value of a training sample, an observation value of the training sample as an initial correction value when initializing the correction values.

That is, the correction values of the predicted values are initialized to be the observation values corresponding to the predicted values. That is, before the correction values are adjusted, the observation values and the correction values of the predicted values are the same.

Step 304: The advertisement push server sorts the predicted values of the training samples in ascending order.

That is, in any two neighboring predicted values, the former predicted value is less than or equal to the latter predicted value.

Herein, the quantity of a predicted value is the same as the quantity of the training samples having the same predicted value, that is, one training sample corresponds to one predicted value. These predicted values may be the same or may be different.

Step 305: The advertisement push server detects, for two neighboring predicted values, whether a correction value of the former predicted value is greater than a correction value of the latter predicted value.

That is, in any two neighboring predicted values, the former predicted value is less than or equal to the latter predicted value, and it is detected whether a correction value of the former predicted value is greater than a correction value of the latter predicted value.

Step 306: The advertisement push server maintains the correction value of the former predicted value and the correction value of the latter predicted value unchanged when the correction value of the former predicted value is less than or equal to the correction value of the latter predicted value.

For example, for any two neighboring predicted values xᵢ and xᵢ₊₁, observation values corresponding to the two neighboring predicted values are yᵢ and yᵢ₊₁ respectively, and correction values before update are fᵢ and f₁₊₁ respectively. When correction values fᵢ′ and fᵢ₊₁′ after the update are solved, it is detected whether fᵢ is less than or equal to fᵢ₊₁.

When fᵢ≦fᵢ₊₁, fᵢ and fᵢ₊₁ are maintained unchanged, that is, fᵢ′=fᵢ and fᵢ₊₁′=fᵢ₊₁, where 1<i≦n−1, and n is a total quantity of predicted values.

Step 307: When the correction value of the former predicted value is greater than the correction value of the latter predicted value, the advertisement push server calculates an average value of the correction values of die two predicted values, and updates the correction value of the former predicted value and the correction value of the latter predicted value with the average value.

When fᵢ>fᵢ₊₁, the average value of the correction values of the two predicted value is calculated, that is, fᵢ′=f_{i+1′}=(fᵢ+fᵢ₊₁)/2.

Correction values of predicted values are calculated according to step 304 to step 307, and it is finally calculated through iteration that in any two neighboring predicted values, a correction value of the former predicted value is less than or equal to a correction value of the latter predicted value.

For example, referring to FIG. 3B, FIG. 3B is a schematic diagram of obtaining a correction value according, to an embodiment of the present invention. In FIG. 3B, x represents a predicted value, y represents an observation value of the predicted value, and f represents a correction value of the predicted value.

In (a) of FIG. 3B, there are five predicted values: 0,1, 2, 3, and 4 (which, are merely examples herein, to represent an ascending order of the predicted values. In an actual application, a predicted value may be a number greater than 1, or may be a number less than 1). Observation values corresponding to the five predicted values are 1, 0, 0, 1, and 0 respectively. After being initialized to be the observation values, the correction values of the predicted values are 1, 0, 0, 1, and 0 respectively.

Referring to step (1) shown in (b) of FIG. 3B, for first two predicted values: the predicted value 0 and the predicted value 1, the correction value 1 of the predicted value 0 is greater than the correction value 0 of the predicted value. Therefore, an average value of the correction value 1 and the correction value 0 is calculated, that is, 0.5, and 0.5 is used as updated correction values of the predicted value 0 and the predicted value 1.

Referring to step (2) shown in (c) of FIG. 3B, the correction value 0.5 of the predicted value 1 is greater than the correction value 0 of the predicted value Therefore, an average value of the correction value of the predicted value 1 and the correction value of the predicted value 2 is calculated, that is, 0.25, and 0.25 is used as updated correction values of the predicted value 1 and the predicted value 2.

Referring to step (3) shown in (d) of FIG. 3B, the correction value 0.5 of the predicted value 0 is greater than the correction value 0.25 of the predicted value 1. Therefore, an average value of the correction value 0 the predicted value 0 and the correction value of the predicted value 1 is calculated, that, is, 0.375, and 0.375 is used as updated correction values of the predicted value 0 and the predicted value 1.

It is determined in sequence that in any two neighboring predicted values, the former predicted value is less than or equal to the latter predicted value. Referring to (e) in FIG. 3B, all former correction values are less than or equal to latter correction values.

As can be known from step 305 to step 307, the correction value is calculated according to an average value of the predicted values. Therefore, the correction value is one order of magnitude lower than the actual predicted value, that is, if the order of magnitude of the predicted value is a single digit, the correction value ranges from 0 to 1. Therefore, the correction value can better reflect an actual click-through rate of a user,

In conclusion, according to the advertisement click-through rate correction method provided in this embodiment of the present invention, predicted click-through rates corresponding to training samples are corrected, to obtain correction values of predicted values. The order of magnitude of a correction value is closer to the order of magnitude of a click-through rate of a user, and an ascending direction of the correction values is the same as an ascending direction of the predicted values. Therefore, when an advertisement is pushed to the user by replacing a predicted value with a correction value, a probability of the advertisement pushed to the user being clicked on can be greatly increased. Therefore, the advertisement click-through rate correction method solves a problem in a:related technology that when a CTRP unit predicts a click-through rate, there is a difference between a predicted CTR and an actual CTR because non-proportional sampling performed on positive samples and negative samples in training samples due to a fume amount of training data; and achieves effects of reducing a difference between a predicted click-through rate and an actual click-through rate and improving a hit ratio of an advertisement pushed to a user.

After calculation is performed on the predicted, value by using the logistic regression model, the order of magnitude of the predicted value and the order of magnitude of the actual observation value may differ significantly. For example, the order of magnitude of the predicted value may be thousand. In this case, it is not convenient for an advertiser to check. When the correction value of the predicted value is determined by using the foregoing method and the actual observation value, it can be ensured that the correction value and the actual click-through rate have a same order of magnitude. For example, a general actual click-through rate ranges from 0 to 1, and a calculated correction value ranges from 0 to 1. In this way, it is more convenient for the advertiser to check and perform statistics collection.

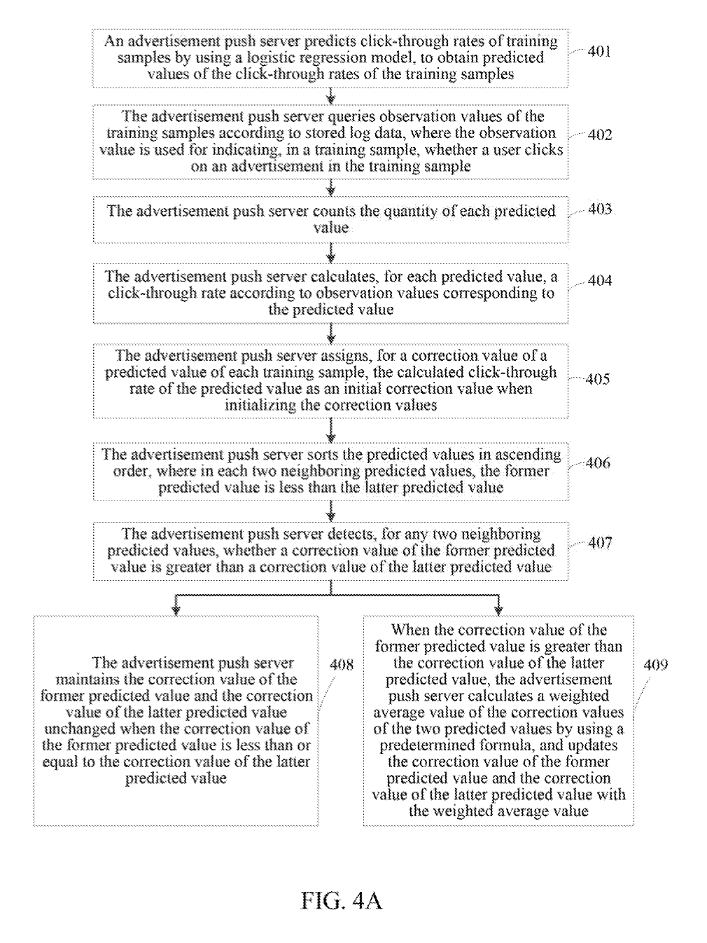

In an actual application, because there is a huge quantity of recorded training samples, when comparison and traversal are performed on the samples one by one, it takes a relatively long time. To meet a requirement on calculation efficiency and achieve second-level update, the manner shown in FIG. 4A may be used. The quantity of identical observation values is counted. For a specific implementation process, refer to the following description about FIG. 4A.

Referring to FIG. 4A, FIG. 4A is a method flowchart of an advertise tent click-through rate correction method according to still another embodiment of the present invention. An example in which the advertisement click-through rate correction method is applied to the advertisement push server shown FIG. 1 is mainly used for description. The advertisement click-through rate correction method may include the following

Step 401: An advertisement push server predicts click-through rates of training samples by using a logistic regression model, to obtain predicted values of the click-through rates of the training samples.

Step 402: The advertisement push server queries observation values of the training samples according to stored log data, where the observation value is used for indicating, in a training sample, whether a user clicks on an advertisement in the training sample.

Step 401 and Step 402 are similar to step 301 and step 302 respectively. For details, refer to the descriptions about step 301 and step 302. Details are not described herein again.

Step 403: The advertisement push server counts the quantity of each predicted value.

Obtained predicted values may be the same when prediction is performed on different training samples. Therefore, there may be multiple identical predicted values when prediction is performed on different training samples. For example, the quantity of predicted values 0.3 is 100, and the quantity of predicted values 20 is 200.

To reduce repeated calculation, identical, predicted values ma be merged, and correction values of the predicted values are calculated by using a merged predicted value and the quantity that corresponds to the predicted value.

Step 404: The advertisement push server calculates, for each predicted value, a click-through rate according to observation values corresponding to the predicted value.

The click-through rate is a value obtained by dividing the quantity of observation values, among all the observation values corresponding to the predicted value, for indicating that the user clicks on the training sample by the quantity of all the observation values corresponding to the predicted value.

For example, when the quantity of all observation values corresponding to one predicted value is 100, and the quantity of observation values, among all the observation values, for indicating that the training sample is clicked on is 20, the click-through rate is 20/100=0.2, that is, the click-through rate corresponding to the predicted value is 0.2.

Step 405: The advertisement push server assigns, for a correction value of a predicted value of each training sample, the calculated click-through rate of the predicted value as an initial correction value when initializing the correction values.

That is, for the correction value of the predicted value of each training sample, the correction value of the predicted value is initialized to be the click-through rate the click-through rate herein is used for indicating an actual observation value that the user clicks on an advertisement) corresponding to the predicted value. That is, before the correction values are adjusted, the observation values of the predicted values are the same as the correction values.

Step 406: The advertisement push server sorts the predicted values in ascending order, where in each two neighboring predicted values, the former predicted value is less than the latter predicted value.

The predicted values are merged. Therefore, the predicted values herein are different predicted values, that is, in each two neighboring predicted values, the former predicted value is less than the latter predicted value. Each predicted value corresponds to one observation value and one quantity value.

Step 407: The advertisement push server detects, for any two neighboring predicted values, whether a correction value of the former predicted value is greater than a correction value of the latter predicted value.

Step 408: The advertisement push server maintains the correction value of the former predicted value and the correction value of the latter predicted value unchanged when the correction value of the former predicted value is less than or equal to the correction value of the latter predicted value.

For example, for any two neighboring predicted values xᵢ and xᵢ₊₁, click-through rates (actual observation values) corresponding to the two neighboring predicted values are yᵢ and yᵢ₊₁ respectively, quantity values corresponding to the two neighboring predicted values are wᵢ and wᵢ₊₁ respectively, and correction values before update are fᵢ and fᵢ₊₁ respectively. When correction values fᵢ′ and fᵢ₊₁′ after the update are solved, it is detected whether fᵢ is less than or equal to fᵢ₊₁.

When fᵢ≦fᵢ₊₁, fᵢ and fᵢ and f₁₊₁ are maintained unchanged, that is, fᵢ′=fᵢ and fᵢ₊₁′=fᵢ₊₁, where 1<i≦n−1, and n is a total quantity of predicted values.

Step 409: When the correction value of the former predicted value is greater than the correction value of the latter predicted value, the advertisement push server calculates a weighted average value of the correction values of the two predicted values by using a predetermined formula (e.g., using the quantities of the predicted values as weights), and updates the correction value of the former predicted value and the correction value of the latter predicted value with the weighted average value.

The predetermined formula herein may be:

f_{w}=(wᵢ*f₁+wᵢ₊₁*Fᵢ₊₁)/(wᵢ+wᵢ₊₁),

where f_{w} is the weighted average value of the correction value of the former predicted value and the correction value of the latter predicted value, wᵢ is the quantity of the former predicted value, fᵢ is the correction value of the former predicted value before the update, wᵢ₊₁ is the quantity of the latter predicted value, and fᵢ₊₁ is the correction value of the latter) predicted value before the update.

Correction values of the predicted values are calculated according to step 407 to step 409, and it is finally calculated through iteration that in any two neighboring predicted values, a correction value of the former predicted value is less than or equal to a correction value of the latter predicted value.

For example, referring to FIG. 4B, FIG. 4B is a schematic diagram of obtaining a correction value according to another embodiment of the present invention. In FIG. 4B, x represents a predicted value, y represents an observation value of the predicted value, f represents a correction value of the predicted value, and w represents the quantity of identical predicted values.

In (a) of FIG. 4B, there are five predicted values: 0, 1, 2, 3, and 4 (which are merely examples herein, to represent an ascending order of the predicted values. In an actual application, the predicted value may be a number greater than 1 or may be a number less than 1). Observation values corresponding to the five predicted values are 0.1, 0, 0, 0.1, and 0 respectively. After being initialized to be the observation values, the correction values of the predicted values are 0.1, 0, 0, 0.1, and 0 respectively. Quantities of the live predicted values are 100, 200, 300, 200, and 100 respectively.

Referring to step (1) shown in (b) of FIG. 4B, for first two predicted values: the predicted value 0 and the predicted value 1, the correction value 0.1 of the predicted value 0 is greater than the correction value 0 of the predicted value 1. Therefore, a weighted average value, of the correction value 0.1 and the correction value 0 is calculated, that is, 0.033, and 0.033 is used as updated correction values of the predicted value 0 and the predicted value 1.

Referring to step (2) shown in (c) of FIG. 4B, the correction value 0.033 of the predicted value 1 is greater than the correction value 0 of the predicted value 2. Therefore, a weighted average value of the correction value of the predicted value 1 and the correction value of the predicted value 2 is calculated, that is, 0.132, and 0.132 is used as updated correction values of the predicted value 1 and the predicted value 2.

Referring to step (3) shown in (d) of FIG. 4B, the correction value 0.033 of the predicted value 0 is greater than the correction value 0.132 of the predicted value 1. Therefore, a weighted average value of the correction value;of the predicted value 0 and the correction value of the predicted value 1 is calculated, that is, 0.099, and 0.099 is, used as updated correction values of the predicted value 1 and the predicted value 1.

It is determined in sequence that in any two neighboring predicted values, the former predicted value is less than or equal to the latter predicted value. Referring to (e) in FIG. 4B, all former correction values are less than or equal to latter correction values.

As can be known from step 406 to step 409, the correction value is calculated according to a weighted average value of the actual click-through rates. Therefore, the, order of magnitude of the correction value is the same as the order of magnitude of the actual click-through rate, that is, the correction value and the actual click-through rate range from 0 to 1. Therefore, the correction value can better reflect the actual click-through rate of a user.

In conclusion, according to the advertisement click-through rate correction method provided in this embodiment of the present invention, predicted click-through rates corresponding to training samples are corrected, to obtain correction values of predicted values. The order of magnitude of a correction value is closer to the order of magnitude of a click-through rate of a user, and an ascending direction of the correction values is the same as an ascending direction of the predicted values. Therefore, when an advertisement is pushed to the user by replacing a predicted value with a correction value, a probability of the advertisement pushed to the user being clicked on can be greatly increased. Therefore, the advertisement click-through rate correction method solves a problem in a related technology that when a CTRP unit predicts a click-through rate, there is a difference between a predicted CTR and an actual CTR because non-proportional sampling performed on positive samples and negative samples in training samples due to a huge amount of training data; and achieves effects of reducing a difference between a predicted click-through rate and an actual click-through rate and improving a hit ratio of an advertisement pushed to a user.

Identical predicted values may be merged. Because this may greatly reduce a calculation amount during calculation of a correction value, duration of pushing an advertisement to a user is greatly reduced, and advertisement push efficiency and user experience are improved.

After calculation is performed on the predicted value by using the, logistic regression model, the order of magnitude of the predicted value and the order of magnitude of the actual observation value may differ significantly. For example, the order of magnitude of the predicted value may be thousand. In this case, it is not convenient for an advertiser to check. When the correction value of the predicted value is determined by using the foregoing method and the actual click-through rate, it can be ensured that the correction value and the actual click-through rate have a same order of magnitude. For example, a general actual click-through rate ranges from 0 to 1, and a calculated correction value ranges from 0 to 1. In this way, it is more convenient for the advertiser to check and perform statistics collection.

In an optional implementation manner, to enable the correction value to be used by the advertisement push server, the advertisement push server stores correspondences between the predicted values and the correction values corresponding to the predicted values into a click-through rate prediction unit of the advertisement push server,

When the correction values are obtained in the implementation manner shown in FIG. 3A, each stored correspondence may include a predicted value and a correction value corresponding to the predicted value.

When the correction values are obtained in the implementation manner shown in FIG. 4A, each stored correspondence may include a correction value and a range formed by predicted values corresponding to the correction value.

Objectives of the embodiments of the present invention are to determine correction values of predicted values, so that when a front-end push unit 12 needs to push an advertisement to a user, a click-through rate prediction unit 16 may predict predicted values, for the user, of preliminarily selected sample advertisements, and determine correction values according to the stored correspondences between the predicted values and the correction values. Then, the click-through rate prediction unit 16 replaces original predicted values with the correction values, to perform refined selection cm the advertisements, and sends the selected advertisements to an optimization unit 17. The optimization unit 17 pushes an optimal advertisement to the user.

That is, when receiving an advertisement push request of a user, the advertisement push server predicts, for the user by using the logistic regression model in the click-through rate prediction unit, predicted values that the user clicks on the preliminarily selected advertisements. The advertisement push server finds, according to the correspondences stored in the click-through rate prediction unit, correction values corresponding to the predicted values. The advertisement push server replaces the predicted values with the found correction values. Then, the advertisement push server may push an advertisement to the user according to an existing subsequent procedure. For example, using the correction values of the predicted values, an updated click-through rate can be obtained, and an advertisement having the highest click-through rate may be pushed to the user in response to the advertisement push request.

The order of magnitude of the predicted values may reach tens, hundreds, and even thousands due to correction, amplification, adjustment and the like of a model such as the logistic regression model. The order of magnitude of the predicted values does not conform to that of actual click-through rates of the user. Therefore, it is not convenient for an advertiser to check and perform analysis. As can be known from the descriptions about FIG. 3A and FIG. 4A, the correction values are obtained according to the observation values. Therefore, the order of magnitude of the correction values conforms to the order of magnitude of the actual click-through rates of the user, end it is convenient for the advertiser to check and perform analysis.

In addition, as can be known according to the implementation in FIG. 3A and FIG. 4A, in this embodiment of the present invention, the predicted values of the click-through rates may be corrected. Therefore, it is no longer necessary to concern about the cause of an error. A predicted value in which an error is generated due to any cause can be corrected. Moreover, the CTRP unit can restore any actual click-through rate without the need to pay attention to a change in a sampling ratio of training samples.

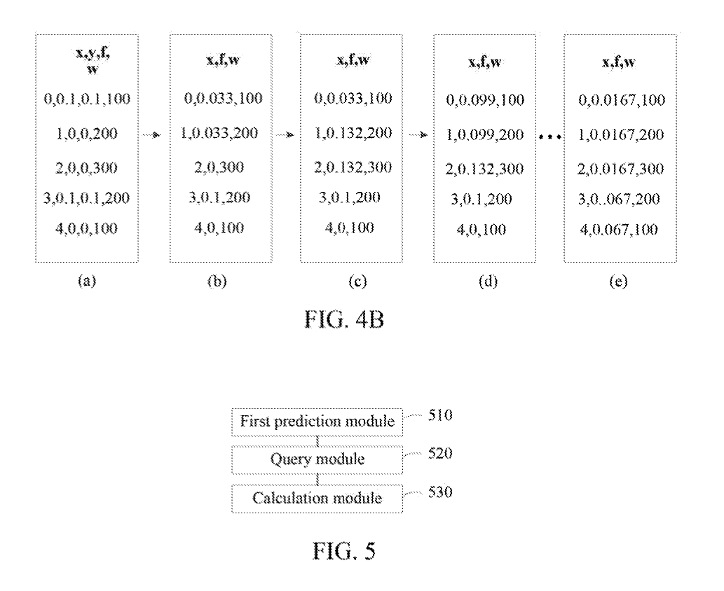

Referring to FIG. 5, FIG. 5 is a structural block diagram of an advertisement click-through rate correction apparatus according to an embodiment of the present invention. The advertisement click-through rate correction apparatus is described mainly by using an example in which the advertiser rent click-through rate correction apparatus is applied to the advertisement push server shown in FIG. 1. The advertisement click-through rate correction apparatus may include: a first prediction module 510, a query module 520, and a calculation module 530.

The first prediction module 510 is configured to predict click-through rates of training samples by using, a logistic regression model, to obtain predicted values of the click-through rates of the training samples.

The query module 520 is configured to query observation values of the training samples according to stored log data, where the observation value is used for indicating, in a training sample, whether a user clicks on an advertisement in the training sample.

The calculation module 530 is configured to: calculate correction values of the predicted values of the training samples according to the observation values of the training samples, so that in two neighboring predicted values, a correction value of the former predicted value is less than or equal to a correction value of the latter predicted value, where the correction value is used for replacing a predicted value corresponding to the correction value when an advertisement is recommended to the user, the order of magnitude of the correction value is the same as the order of magnitude of an actual click-through rate, and in the two neighboring predicted values, the former predicted value is less than or equal to the latter predicted value.

In conclusion, the advertisement click-through rate correction apparatus provided in this embodiment of the present invention corrects predicted click-through rates corresponding to training samples, to obtain correction values of the predicted values. The order of magnitude of a correction value is closer to the order of magnitude of a click-through rate of a user, and an ascending direction of the correction values is the same as an ascending, direction of the predicted values. Therefore, when an advertisement is pushed to the user by replacing a predicted value with a correction value, a probability of the advertisement pushed to the user being clicked on can be greatly increased. Therefore, the advertisement click-through rate correction apparatus solves a problem a related technology that when a CTRP unit predicts a click-through rate, there is a difference between a predicted CTR and an actual CTR because non-proportional sampling is performed on positive samples and negative samples in training samples due to a huge amount of training data; and achieves effects of reducing a difference between a predicted click-through rate and an actual click-through rate and improving a hit ratio of an advertisement pushed to a user.

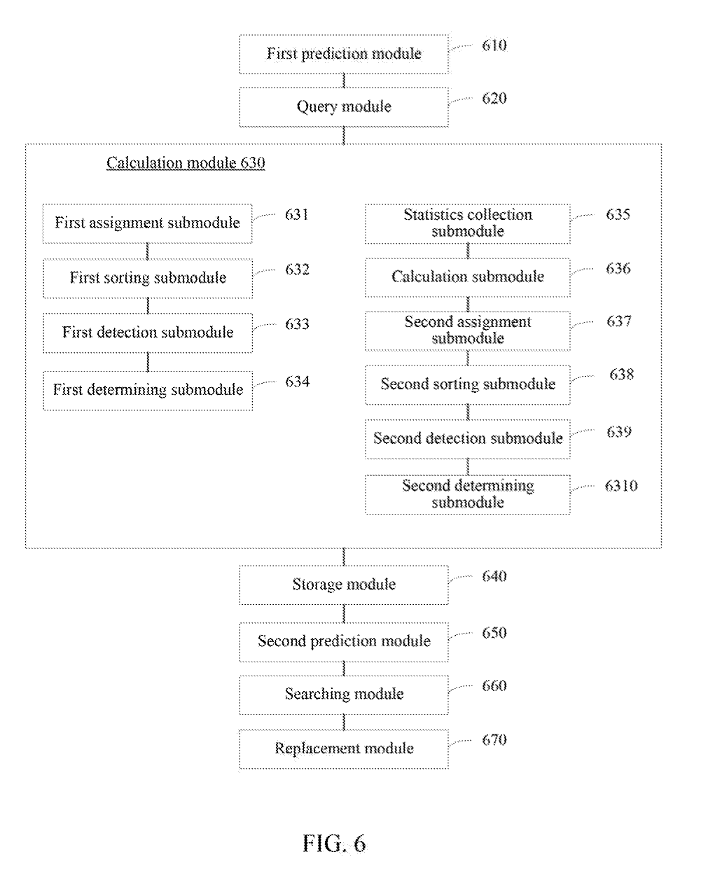

Referring to FIG. 6, FIG. 6 is a structural block diagram of an advertisement click-through rate correction apparatus according to another embodiment of the present invention. The advertisement click-through rate correction apparatus is described mainly by using an example in which the advertisement click-through rate correction apparatus is applied to the advertisement push server shown in FIG. 1. The advertisement click-through rate correction apparatus, may include: a first prediction module 610, a query module 620, and a calculation module 630.

The first prediction module 610 may be configured to predict click-through rates of training, samples by using a logistic regression model, to obtain predicted values of the click-through rates of the training samples.

The query module 620 may be configured to query observation values of the training samples according to stored log data, where the observation value is used for indicating, in a training sample, whether a user clicks on an advertisement in the training sample.

The calculation module 630 may be configured to: calculate correction values of the predicted values of the training samples according to the observation values of the training samples, so that in two neighboring predicted values, a correction value of the former predicted value is less than or equal to a correction value of the latter predicted value, where the correction value is used for replacing a predicted value corresponding to the correction value when an advertisement is recommended to the, user, the order of magnitude of the correction value is the same as the order of magnitude of an actual click-through rate, and in the two neighboring predicted values, the former predicted value is less than or equal to the latter predicted value,)

In a possible implementation manner, the calculation module 630 may include: a first assignment submodule 631, a first sorting submodule 632, a first detection submodule 633, and a first determining submodule 634.

The first assignment submodule 631 may be configured to: assign, for a correction value of a predicted value of each training sample, an observation value of the predicted value to the correction value when the correction values are initialized.

The first sorting submodule 632 may be configured to sort the predicted values of the training samples in ascending order.

The first detection submodule 633 may be configured to detect, for any two neighboring predicted values, whether a correction value of the former predicted value is greater than a correction value of the latter predicted value.

The first determining submodule 634 may be configured to: when the first detection submodule 633 detects that the correction value of the former predicted value is greater that the correction value of the latter predicted value, calculate an average value of the correction values of the two predicted values, and update the correction value of the former predicted value and the correction value of the latter predicted value with the average value.

In a possible implementation manner, the calculation module 630 may include: a statistics collection submodule 635, a calculation submodule 636, a second assignment submodule 637, a second sorting submodule 638, a second detection submodule 639, and a second determining submodule 6310.

The statistics collection submodule 635 may be configured to count the quantity of each predicted value.

The calculation submodule 636 may be configured to calculate, for each predicted value, a click-through rate according to observation values corresponding to the predicted value, where the click-through rate is a value obtained by dividing the quantity of observation values, among all the observation values corresponding to the predicted value, for indicating that the user clicks on the training sample by the quantity of all the observation values corresponding to the predicted value.

The second assignment submodule 637 is configured to: assign, for a connection value of a predicted value of each training sample, the calculated click-through rate of the predicted value to the correction value when the correction values are initialized.

The second sorting submodule 638 may be configured to sort the predicted values in ascending order where in each two neighboring predicted values, the former predicted value is less than the latter predicted value.

The second detection submodule 639 may be configured to: detect, for any two neighboring predicted values, whether a correction value of the former predicted value is greater than a correction value of the latter predicted value.

The second determining submodule 6310 may be configured to: when the second detection submodule 639 detects that the correction value of the former predicted value is greater than the correction value of the latter predicted value, calculate a weighted average value of the correction values of the two predicted value by using a predetermined formula, and update the correction value of the former predicted value and the correction value of the latter predicted value with the weighted average value.

In a possible implementation manner, the predetermined formula is:

f_{w}(wᵢ*f₁+wᵢ₊₁*fᵢ₊₁)/(wᵢ+wᵢ₊₁),

where f_{w} is the weighted average value of the correction value of the former predicted value and the correction value of the latter predicted value, wᵢ is the quantity of the former predicted value, fᵢ is the correction value of the former predicted value before the update, wᵢ₊₁ is the quantity of the latter predicted value, and fᵢ₊₁ is the correction value of the latter predicted value before the update.

In a possible implementation manner, the advertisement click-through rate correction apparatus may further include a storage module 640.

The storage module 640 may be configured to store correspondences between the predicted values and the correction values corresponding to the predicted values into a click-through rate prediction unit of the advertisement push server, where each correspondence includes a predicted value and a correction value corresponding to the predicted value, or each correspondence includes a correction value and a range formed by predicted values corresponding to the correction value.

In a possible implementation manner, the advertisement click-through rate correction apparatus may further include: a second prediction module 650, a searching module 660, and a replacement module 670.

The second prediction module 650 may be configured to: when an advertisement push request of a user is received, predict, for the user by using the logistic regression model in the click-through rate prediction unit, predicted values that the user clicks on preliminarily selected advertisements.

The searching module 660 may be configured to find, according to the correspondences stored in the click-through rate prediction unit (e.g., the first prediction module, or the second prediction module), correction values corresponding to the predicted values.

The replacement module 670 may be configured to correspondingly replace the predicted values with the found correction values respectively.

In conclusion, the advertisement click-through rate correction apparatus provided in this embodiment of the present invention corrects predicted click-through rates corresponding to the training samples are corrected, to obtain correction values of the predicted values. The order of magnitude of a correction value is closer to the order of magnitude of a dick-through rate of a user, and an ascending direction of the correction values is the same as an ascending direction of the predicted values. Therefore, when an advertisement is pushed to the user by replacing a predicted value with a correction value, a probability of the advertisement pushed to the user being clicked on can be greatly increased. Therefore, the advertisement click-through rate correction apparatus solves a problem in a related technology that when a CTRP unit predicts a click-through rate, there is a difference between a predicted CTR and an actual CTR because non-proportional sampling is performed on positive samples and negative samples in training samples due to a huge amount of training data; and achieves effects of reducing a difference between a predicted click-through rate and an actual click-through rate and improving a hit ratio of an advertisement pushed to a user.

Identical predicted values may be merged. Because this may greatly reduce a calculation amount during calculation of a correction value, duration of pushing are advertisement to a user is greatly reduced, and advertisement push, efficiency and user experience are improved.

After calculation is performed on the correction value by using the logistic regression model, the order of magnitude of the predicted value and the order of magnitude of the actual observation value may differ significantly. For example, the order of magnitude of the predicted value may be thousand. In this case, it is not convenient for an advertiser to check. Therefore, a click-through rate of an advertisement is usually a value less than 1. When the correction value of the predicted value is determined by using the foregoing method and the actual observation value, it may be ensured that the correction value rand the actual click-through rate have a same order of magnitude. It is more convenient for the advertiser to check and perform statistics collection.

The predicted values of the click-through rates may be corrected. Therefore, it is no longer necessary to concern about the cause of an error. A predicted value in which an error is generated due to any cause can be corrected. Moreover, the CTRP unit can restore any actual click-through rate without the need to pay attention to a change in a sampling ratio of training samples.

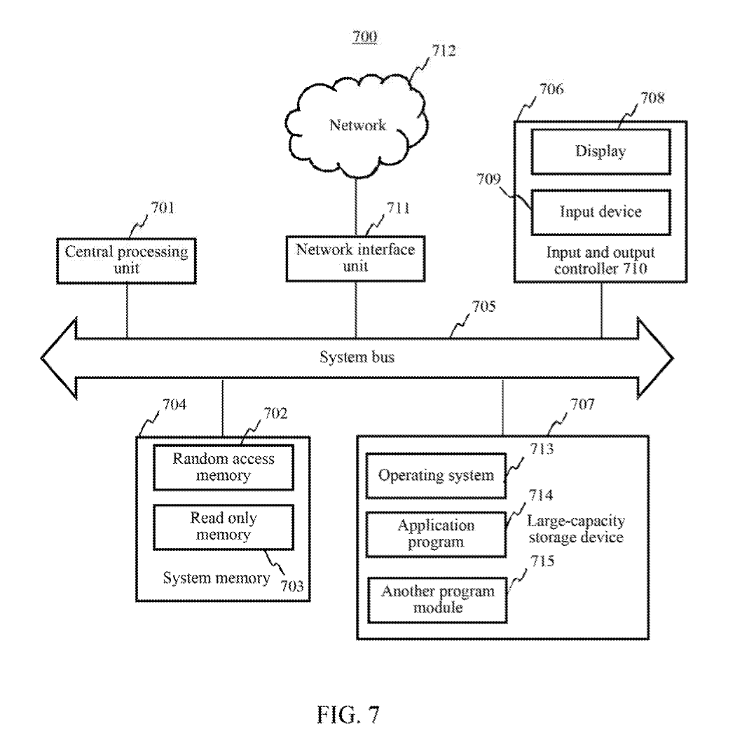

FIG. 7 is a schematic structural diagram of an advertisement push server according to an embodiment of the present invention. The advertisement push server 700 includes: a central processing unit (CPU) 701, a system memory 704 including a random access memory (RAM) 702 and a read-only memory (ROM) 703, and a system bus 705 connecting the system memory 704 and the central processing unit 701. The advertisement push server 700 further includes a basic input output (110) system 706 helping information transmission between components in a computer, and a large-capacity storage device 707 configured to store an operating, system 713, an application program 714, and another program module 715.

The basic input/output system 706 includes a display 708 configured to display information, and an input device 709 configured to enter information by a user, such as a mouse and a keyboard. The display 708 and the input device 709 are both connected to the central processing unit 701 by using the system bus 705 connected to an input/output controller 710. The basic input output system 706 may further include the input/output controller 710, to receive and process input from multiple other devices such as a keyboard, a mouse, and an electronic stylus. Similarly, the input/output controller 710 further provides output to a display screen, a printer, or another type of output device.

The large-capacity storage device 707 is connected to the central processing unit 701 by using a large-capacity storage controller (not shown) connected to the system bus 705. The large-capacity storage device 707 and a computer readable medium associated with the large-capacity storage device 707 provide non-volatile storage to the advertisement push server 700. That is, the large-capacity storage device 707 may include a computer readable medium (not shown) such as a hard disk or a CD-ROM drive.

In general, the computer readable medium may include a computer storage medium and a communications medium. The computer storage medium includes volatile, non-volatile, removable, and non-removable media implemented by using any method or technology used for storing information such as a computer readable instruction, a data structure, a program module, or other data. The computer storage medium includes a static random access memory (SRAM), an electrically erasable programmable read-only memory (EEPROM), an erasable programmable read only memory (EPROM), a programmable read only memory (PROM), a RAM, a ROM, a flash memory or another solid state storage technology, a CD-ROM, a digital versatile disc (DVD) or another optical storage, a cassette, a tape, and a magnetic disk storage or another magnetic, storage device. Certainly, a person skilled in the art may know that the computer storage medium is a of limited to the foregoing types. The system memory 704 and the large-capacity storage device 707 may be collectively referred to as a memory.

According to the embodiments of the present invention, the advertisement push server 700 may run by using a remote computer connecting to a network via a network such as the Internet. Thai is, the advertisement push server 700 may connect to a network 712 by using a network interface unit 711 connected to the system bus 705, or may connect to another type of network or a remote computer system (not shown) by using the network interface unit 711.

The advertisement push server may include: one or more processors; and a memory, where the memory stores one or more programs, the one or more programs are configured to be executed by the one or more processors, and the one or more programs include instructions for performing the following operations: predicting click-through rates of training samples by using a logistic regression model, to obtain predicted values of the click-through rates of the training samples; querying observation values of the training samples according to stored log data, where the observation value is used or indicating, in a training sample, whether a user clicks on, an advertisement in the training sample; and calculating correction values of the predicted values of the training samples according to the observation values of the training samples, so that in two neighboring predicted values, a correction value of the former predicted value is less than or equal to a correction value of the latter predicted value, where the correction value is used for replacing a predicted value corresponding to the correction value when an advertisement is recommended to the user, the order of magnitude of the correction value is the same as the order of magnitude of an actual click-through and in the two neighboring predicted values, the former predicted value is less than or equal to the latter predicted value.

Optionally, the one or more programs further include instructions for performing the following operations: assigning, for a correction value of a predicted value of each training sample, an observation value of the predicted value to the correction value when the correction values are initialized; sorting the predicted values of the training samples in ascending order; detecting, for any two neighboring predicted values, whether a correction value of the former predicted value is greater than a correction value of the latter predicted value; and calculating an average value of the correction values of the two predicted values, and updating the correction value of the former predicted value and the correction value of the latter predicted value with the average value, when it is detected that the correction value of the former predicted value is greater than the correction value of the latter predicted value.

Optionally, the one or more programs further include instructions for performing the following operations: counting the quantity of each predicted value; calculating, for each predicted value, a click-through rate according to observation values corresponding to the predicted value, where the click-through rate is a value obtained by dividing the quantity of observation values, among all the observation values corresponding to the predicted value, for indicating that the user clicks on the training sample by the quantity of all the observation values corresponding to the predicted value; assigning, for a correction value of a predicted value of each training sample, the calculated click-through rate of the predicted value to the correction value when the correction values are initialized; sorting the predicted values in ascending order, where in each two neighboring predicted values, the former predicted value is less than the latter predicted value; detecting, for any two neighboring predicted values, whether a correction value of the former predicted value is less than or equal to a correction value of the latter predicted value; and calculating a weighted average value of the correction values of the two predicted values by using a predetermined formula, and updating the correction value of the former predicted value and the correction value of the latter predicted value with the average value, when it is detected that the correction value of the former predicted value is a greater than the correction value of the latter predicted value.

Optionally, the predetermined formula is:

f_{w}=(wᵢ*fᵢ+wᵢ₊₁*fᵢ₊₁)/(wᵢ+wᵢ₊₁),

where f_{w} is the weighted average value of the correction value of the former predicted value and the correction value of the latter predicted value, wᵢ is the quantity of the former predicted value, fᵢ is the correction value of the former predicted value before the update, is the quantity of the latter predicted value, and fᵢ₊₁ is the correction value of the latter predicted value before the update.

Optionally, the one or more programs further include instructions for performing the following operations: storing correspondences between the predicted values and the correction values corresponding to the predicted values into a click-through rate prediction unit of the advertisement push server, where each correspondence includes a predicted value and a correction value corresponding to the predicted value, or each correspondence includes a correction value a range formed by predicted values corresponding to the correction value.

Optionally, the one or more programs further include instructions for performing the following operations: predicting, for a user by using the logistic regression model in the click-through rate prediction unit when an advertisement push request of the user is received, predicted values that the user clicks on preliminarily selected advertisements; finding, by the advertisement push server according to the stored correspondences, correction values corresponding to the predicted values; and correspondingly replacing the predicted values by using the found correction values respectively.

In an exemplary embodiment, a non-temporary computer readable storage medium including instructions is further provided, for example, a memory including instructions. The instructions may be executed by the processor in the advertisement push server, to complete the advertisement click-through rate correction method in the following embodiment. For example, the non-temporary computer readable storage medium may be a ROM, a random access memory (RAM), a CD-ROM, a tape, floppy disk, an optical data storage device, and the like.

It should be noted that when the advertisement click-through rate correction apparatus and the advertisement push server that are provided in the foregoing embodiments correct an advertisement click-through rate, the division of the foregoing function modules is merely used as an example for description. In an actual application, the functions are allocated to and completed by different function modules according to requirements, that is, the internal structure of the advertisement push server is divided into different function modules, so as to complete all or some of the functions described above. In addition, the advertisement click-through rate correction apparatus and the advertisement push server provided in the foregoing embodiments belong to a same concept as the embodiment of the advertisement click-through rate correction method. For specific implementation processes thereof, refer to the method embodiment, and details are not described herein again.

The sequence numbers of the foregoing embodiments of the present invention are merely for the convenience of description, and do not imply the preference among the embodiments.

A person of ordinary skill in the art may understand that all or some of the steps of the embodiments may be implemented by hardware, or may be implemented by a program by instructing related hardware. The program may be stored in a computer readable storage medium. The storage medium may be a read-only memory, a magnetic disk, or an optical disc.

The foregoing descriptions are merely examples of the embodiments of the present invention, hot are not intended to limit the present disclosure. Any modification, equivalent replacement, and improvement made without departing from the spirit and principle of the present disclosure shall fall within the protection scope of the present disclosure.

What is claimed is:

1. An advertisement click-through rate correction method, comprising:
predicting, by an advertisement push server, click-through rates of training samples by using a logistic regression model, to obtain predicted values associated with the click-through rates of the training samples;
querying, by the advertisement push server, observation values of the training samples according to stored log data, the observation value indicating, in a training sample, whether a user clicks on an advertisement in the training sample; and
calculating, by the advertisement push server, correction values of the predicted values of the training samples according to the observation values of the training samples, so that in two neighboring predicted values including a former predicted value and a latter predicted value, a first correction value of the former predicted value is less than r equal to a second correction value of the latter predicted value, the correction value being used for replacing a corresponding predicted value when an advertisement is recommended to the user, the order of magnitude of the correction value being the same as the order of magnitude of an actual click-through rate, and in the two neighboring predicted values, the former predicted value being less than or equal to the latter predicted value.

2. The method according to claim 1, wherein the calculating, by the advertisement push server, correction values of the predicted values of the training samples according to the observation values of the training samples comprises:
assigning, for a correction value of a predicted value of a training sample, an observation value of the training sample as an initial correction value when the advertisement push server initializes the correction values;
sorting, by the advertisement push server, the predicted values of the training samples in ascending order;
detecting, by the advertisement push server for the two neighboring predicted values, whether the first correction value of the former, predicted value is greater than the second correction value of the latter predicted value; and
calculating, by the advertisement push server, an average value of the first correction value and the second correction value, and updating the first correction value of the former predicted value and, the second correction value of the latter predicted value using the average value, when the first correction value of the former predicted value is greater than the second correction value of the latter predicted value.

3. The method according to claim 1, wherein the calculating, by the advertisement push server, correction values of the predicted values of the training samples according to the observation values of the training samples comprises:
counting, by the advertisement push server, a quantity of training samples having a same predicted value;
calculating, by the advertisement push server, a click-through rate according to observation values corresponding to the training samples having the same predicted value;
assigning, for a correction value of a predicted value of a training sample, the calculated click-through rate of the predicted value as an initial correction value, when the advertisement push server initializes the correction values;
sorting, by the advertisement push server, the predicted values in ascending order, wherein in the two neighboring predicted values, the former predicted value is less than the latter predicted value;
detecting, by the advertisement push server for the two neighboring predicted values, whether the first correction value of the former predicted value is a greater than the second correction value of the latter predicted value;
calculating, by the advertisement push server, a weighted average value of the first correction value and the second correction value by using a predetermined formula; and
updating the first correction value of the former predicted value and the second correction value of the latter predicted value using the weighted average value, when the correction value of the former predicted value is a greater than the correction value of the latter predicted value.

4. The method according to claim 3, wherein the predetermined formula is:
f_{w}=(wᵢ*fᵢ+w₁₊₁*fᵢ₊₁)/(wᵢ+qᵢ₊₁),
wherein f_{w} is the weighted average value of the first correction value of the former predicted value and the second correction value of the latter predicted value, w is the quantity of training samples having the former predicted value, fᵢ is the first correction value of the former predicted value before the update, wᵢ₊₁ is the quantity of training samples having the latter predicted value, and fᵢ₊₁ is the second correction value of the latter predicted value before the update.

5. The method according to claim 1, further comprising:
storing, by the advertisement push server, correspondences between the predicted values and the correction values corresponding to the predicted values into a click-through rate prediction unit of the advertisement push server, wherein
a correspondence comprises a predicted value and a correction value corresponding to the predicted value, or a correction value and a range formed by predicted values corresponding to the correction value.

6. The method according to claim 5, further comprising:
predicting, for a user by using the logistic regression model in the click-through rate prediction unit when the advertisement push server receives an advertisement push request of the user, predicted values that the user clicks on preliminarily selected advertisements;
finding, by the advertisement push server according to the correspondences stored in the click-through rate prediction unit, correction values corresponding to the predicted values; and
replacing, by the advertisement push server, the predicted values with the found correction values respectively.

7. An advertisement push server, comprising:
one or more processors; and
a memory, wherein
the memory stores one or more programs, the one or more programs are configured to be executed by the one or more processors, and the one or more programs comprise instructions for performing the following operations:
predicting click-through rates of training samples by using a logistic regression model, to obtain predicted values of the click-through rates associated with the training samples;
querying observation values of the training samples according to stored log data, the observation value indicating, in a training sample, whether a user clicks on an advertisement in the training sample; and
calculating correction values of the predicted values of the training samples according to the observation values of the training samples, so that in two neighboring predicted values including a former predicted value and a latter predicted value, a first correction value of the former predicted value is less than or equal to a second correction value of the latter predicted value, the correction value being used for replacing a corresponding predicted value when an advertisement is recommended to the user, the order of magnitude of the correction value being the same as the order of magnitude of an actual click-through rate, and i the two neighboring predicted values, the former predicted value being less than or equal to the latter predicted value.

8. The advertisement push server according to claim 7, wherein the one or more programs further comprise instructions for performing the following operations;
assigning, for a correction value of a predicted value of a training sample, an observation value of the training sample as an initial correction value when the correction values are initialized;
sorting the predicted values of the training samples in ascending order;
detecting, for the two neighboring predicted values, whether the first correction value of the former predicted value is greater than the second correction value of the latter predicted value; and
calculating an average value of the first correction value and the second correction value, and updating the fast correction value of the former predicted value and the second correction value of the latter predicted value with the average value, when it is detected that the first correction value of the former predicted value is greater than the second correction value of the latter predicted value.

9. The advertisement push server according to claim 7, wherein the one or more programs further comprise instructions for performing the following operations:
counting a quantity of training samples having a same predicted value
calculating a click-through rate according, to observation values corresponding to the training samples having the same predicted value;
assigning, for a correction value of a predicted value of a training sample, the calculated click-through rate of the predicted value as an initial correction value when the correction values are initialized;
sorting the predicted values in ascending order, wherein in the two neighboring predicted values, the former predicted value is less than the latter predicted value;
detecting, for the two neighboring predicted values, whether the first correction value of the former predicted value is greater than the second correction value of the latter predicted value; and
calculating, the advertisement push server, a weighted average value of the first correction value and the second correction value by using a predetermined formula, and updating the first correction value of the former predicted value and the second correction value of the latter predicted value with the weighted average value, when it is detected that the correction value of the former predicted value is greater than the correction value of the latter predicted value.

10. The advertisement push server according to claim 9, wherein the predetermined formula is:
f_{w}=(wᵢ*fᵢ+wᵢ₊₁*f_{i°1})/(wᵢ+wᵢ₊₁),
wherein f_{w} is the weight d average value of the first correction value of the former predicted value and the second correction value of the latter predicted value, wᵢ is the quantity of training samples having the former predicted value, fᵢ is the first correction value of the former predicted value before the update, wᵢ₊₁ is the quantity of training samples having the latter predicted value, and fᵢ₊₁ is the second correction value, of the latter predicted value before the update.

11. The advertisement push server according to claim 1, wherein the one or more programs further comprise instructions for performing the following operations:
storing correspondences between the predicted values and the correction values corresponding to the predicted values into a click-through rate prediction unit of the advertisement push server, wherein
a correspondence comprises a predicted value and a correction value corresponding to the predicted value, or a correction value and a range formed by predicted values corresponding to the correction value.

12. The advertisement push server according to claim 11, wherein the one or more programs further comprise instructions for performing the following operations:
predicting, for a user by using the logistic regression model in the click-through rate prediction unit when an advertisement push request of the user is received, predicted values that the user clicks on preliminarily selected advertisements;
finding, by the advertisement push server according to the stored correspondences, correction values corresponding to the predicted values; and
replacing the predicted values with the found correction values respectively.

13. A non-transitory computer-readable storage medium comprising computer-executable program for, when being executed by a processor, performing an advertisement click-through rate correction method, the method comprising:
predicting click-through rates of training samples by using a logistic regression model, to obtain sorted predicted values associated with the click-through rates of the training samples, wherein in two neighboring predicted values including a former predicted value and a latter predicted value, the former predicted value is no greater than the latter predicted value;
querying observation values of the training samples according to stored log data, the observation value indicating, in a training sample, whether a user clicks on an advertisement in the training sample; and
calculating correction values of the predicted values of the training samples according to the observation values of the training samples, so that in the two neighboring predicted values, a first correction value of the former predicted value is less than or equal to a second correction value of the latter predicted value, the correction value being used for replacing a corresponding predicted value of the training sample, when the advertisement corresponding to the training sample is recommended to the user.

14. The non-transitory computer-readable storage medium according to claim 13, wherein the calculating, by the advertisement push server, correction values of the predicted values of the training samples according to the observation values of the training samples comprises:
assigning, for a correction value of a predicted value of a training sample, an observation value of the training sample as an initial correction value when initializing the correction values;
sorting the predicted values of the training samples in ascending order;
detecting, for the two neighboring predicted values, whether the first correction value of the farmer predicted value is greater than the second correction value of the latter predicted value, and
calculating, an average value of the first correction value and the second correction value, and updating the first correction value of the former predicted value and the second correction value of the latter predicted value using the average value, when the first correction value of the former predicted value is greater than the second correction value of the latter predicted value.

15. The non-transitory computer-readable storage medium according to claim 13, wherein the calculating, by the advertisement push server, correction values of the predicted values of the training samples according to the observation values of the training samples comprises:
counting a quantity of training samples having a same predicted value;
calculating a click-through rate according to observation values corresponding to the training samples having the same predicted value;
assigning, for a correction value of a predicted value of a training sample, the calculated click-through rate of the predicted value as an initial correction value, when the correction values are initialized;
sorting the predicted values in ascending order, wherein in the two neighboring predicted values, the former predicted value is less than the latter predicted value;
detecting, for the two neighboring predicted values, whether the first correction value of the former predicted value is greater than the second correction value of the latter predicted value;
calculating a weighted average value of the first correction value and the second correction value by using a predetermined formula, and
updating the first correction value of the former predicted value and the second correction value of the latter predicted value using the weighted average value, when the correction value of the former predicted value is mater than the correction value of the latter predicted value.

16. The noir-transitory computer-readable storage medium according to claim 15, wherein the predetermined formula is
f_{w}=(wᵢ*fᵢ+wᵢ₊₁*fᵢ₊₁)/(wᵢ+wᵢ₊₁),
wherein f_{w} is the weighted average value of the first correction value of the former predicted value and the second correction value of the latter predicted value, wᵢ is the quantity of training samples having the former predicted value, f is the first correction value of the former predicted value before the update, wᵢ₊₁ is the quantity of training samples having the latter predicted value, and fᵢ₊₁ is the second correction value of the latter predicted value before the update.

17. The non-transitory computer-readable storage medium according to claim 13, the method farther comprising:
storing correspondences between the predicted values ant the correction values corresponding to the predicted values,
wherein a correspondence comprises a predicted value and a correction value corresponding to the predicted value, or a correction value and a range formed by predicted values, corresponding to the correction value.

18. The non-transitory computer-readable storage medium according to claim 17, the method further comprising:
predicting, for a user by using the logistic regression model when an advertisement push request of the user is received, predicted values that the user clicks on preliminarily selected advertisements;
finding, according to the stored correspondences, correction values corresponding to the predicted values; and
replacing the predicted values with the found correction values respectively.
